(19) United States
(12) Patent Application Publication
(10) Pub. No.: US 2005/0033820 A1
(43) Pub. Date: Feb. 10, 2005

(54) Method for accessing data of an automation apparatus and corresponding automation apparatus

(76) Inventor: Gunter Steindl, Poppenricht (DE)

Correspondence Address: Siemens Corporation;Intellectual Property Department, 170 Wood Avenue South, Iselin, NJ, 08830, US

(21) Appl. No.: 10/495,831

(22) PCT Filed: Nov. 6, 2002
(86) PCT No.: PCT/DE02/04116

(30) Foreign Application Priority Data
Nov. 22, 2001 (DE) 101 57 251.4

(51) Int. Cl. G06F 15/16

(52) U.S. Cl. 709/213; 709/246

(57) ABSTRACT

The invention relates to a method for accessing data of an automation apparatus and an automation apparatus suitable for the embodiment thereof, wherein access to data on a remote terminal is carried out by means of a remote terminal in accordance with a standard protocol, wherein the automaton apparatus has a client and/or server for handling communication tasks in accordance with the standard protocol and a converter for converting a communication task into a format that can be processed by a functional interface into an internal functionality of the automation apparatus for direct access to the data thereof.

### CROSS REFERENCE TO RELATED APPLICATIONS

This application is the US National Stage of International Application No. PCT/DE02/04116, filed Nov. 6, 2002 and claims the benefit thereof. The International Application claims the benefits of German application No. 10157251.4 filed Nov. 22, 2001, both of the applications are incorporated by reference herein in their entirety.

### FIELD OF INVENTION

The invention relates to a method for accessing data of an automation device. The invention also relates to an automation device which is suitable for executing the method.

### BACKGROUND OF INVENTION

Automation devices are used for controlling and/or monitoring technical processes. Special automation devices are known as so-called stored programmable controls. Other special automation devices are formed by a so-called process computer. Automation devices only differ from so-called standard computers, like those used today for office applications, by virtue of extended connection possibilities, a reduced specific functionality, and the suitability for use in industrial environments. The extended connection possibilities result from the need to connect the process peripheral equipment to the automation device, in order to receive data from the process which is being controlled and/or monitored and in order to output control information to the process. For use in normal industrial environments, a special casing or a suitable shielding is provided in order to protect against damage by mechanical or chemical effects or against electromagnetic interference effects. The functionality is essentially reduced to controlling and monitoring functions and the associated necessary processing functions.

These known automation devices have a memory, in which an object model is stored, and a functional interface which is also stored in the memory and allows an access to the object model. The automation devices of Siemens AG having the designation SIMATIC S7-300 or SIMATIC S7-400 are cited by way of example.

On the one hand, the object model of the automation device describes the organization of the data stored in the automation device, but on the other hand it also includes the stored data itself, namely e.g. so-called organization modules, abbreviated to OB, so-called data modules, abbreviated to DB, so-called function modules, abbreviated to FB, so-called function calls, abbreviated to FC, and so-called system function calls, abbreviated to SFC, to name but a few. These can be accessed by means of the function interface, using functions which are defined for the automation device. The totality of the operation modules and function modules forms the actual control program. In addition, the object model includes so-called data modules, in which data is stored for internal linking or for storing intermediate results. The object model also includes a further input storage area and output storage area, in which are stored the data which is received from the process and the data for outputting to the process respectively.

EP-A-0 540 903 discloses an automation device having a network interface. The user program, inter alia, can be loaded into the control module via this interface.

WO-A-91 14988 discloses an automation device having a bus-compatible interface. However, this interface is not used as a program interface.

Each of the known automation devices has the disadvantage that, due to the restricted functionality of the automation device, an exchange of data between an automation device and a “standard computer” is only possible under certain conditions because, in addition to so-called inputs and outputs for connecting the process peripheral equipment, only one interface is provided for connecting a programming device, which is also proprietary, by means of a communication protocol which is defined for this purpose.

### SUMMARY OF INVENTION

The present invention addresses the problem of specifying a method which allows the data of an automation device to be called up or modified by the additional means of a standard computer.

In accordance with the invention, this problem is solved using a method for accessing data of an automation device as claimed in claim 1. In this case, the automation device has a memory and a function interface as disclosed in the prior art. The function interface is itself stored in the memory of the automation device and allows an access to the object model which is stored in the memory of the automation device. The object model includes at least the control program which is executed on the automation device or by the automation device and the data which is required for executing the control program, e.g. data received from a technical process which is controlled by the control program, and data which is used for controlling the technical process.

In accordance with the invention, provision is made for the object model of the automation device to be accessible via a communication connection, for which a standard protocol can be used. To this end, a communication request which relates to the object model is forwarded from a client or a server to a converter, which converts the communication request into a format which can be processed by the function interface.

A so-called FTP (FTP=File Transfer Protocol) or NFS (NFS=Network File System) connection is cited here as a connection having a standard protocol. The File Transfer Protocol is based on a so-called client-server architecture. When this protocol is used, data is exchanged between a so-called FTP server and a so-called FTP client accordingly. The data is stored on an FTP server; the data transmission involves one or more FTP clients which access the server. FTP allows a data transfer both from the client to the server and from the server to the client. A standard FTP server therefore offers the minimum functionality of being able to display the content of its data resources to an FTP client (directory), being able to transmit data to an FTP client (get/read), or being able to receive data from an FTP client (put/write). A standard FTP client correspondingly offers the minimum functionality of being able to call up a display of the content of the data resources of an FTP server (directory), being able to receive data from an FTP server (get/read) or being able to transmit data to an FTP server (put/write).

In order to make the data additionally available outside of the relevant automation device, or available to devices which are designed in any case for exchanging data with the relevant automation device, a client or a server for handling the selected standard protocol is used in conjunction with the converter which converts accesses e.g. via an FTP server into accesses to the automation device.

If a device which is designed in any case for exchanging data with the relevant automation device, e.g. a so-called programming device, is to read a data module from the automation device, e.g. the data module with the number 1 which is abbreviated to DB 1 below, the function which transfers the data module to the programming device is selected accordingly. For this purpose, the automation device includes a corresponding collection of functions in its function interface, said functions allowing the different accesses, e.g. “read”, “write”, etc., made by the programming device to the object model of the automation device.

IF a terminal which is not especially designed for exchanging data with the relevant automation device, e.g. a so-called personal computer, is to read the same data module from the automation device, this must be done using the functions of the standard protocol. Various applications for use with the relevant terminal are available for handling the standard protocol on the personal computer side. However, the automation device is not directly capable of interpreting the standard protocol which is selected in each case. Therefore the converter acts as an intermediary between client or server and the function interface. Communication requests in accordance with the standard protocol are transformed by the converter into a format which can be processed by the function interface. If data is to be written to the object model of the automation device, this is initially done using a write function (put/write) in accordance with the standard protocol, said write function being converted by the converter into a write function which can be handled by the function interface. If data is to be read from the object model of the automation device, this is initially done using a read function (get/read) in accordance with the standard protocol, said read function being converted by the converter into a read function which can be handled by the function interface.

Appropriate developments of the method as claimed in Claim 1 are the subject matter of the dependent claims which refer back to this claim.

In accordance with a configuration of the claimed method, the converter also converts a communication request from the function interface into a format which can be processed by the client or the server, and forwards the converted communication request to the client or the server. The advantage of such a configuration is that the automation device can also function as an active communication partner in a communication relationship and, for example, can transfer relevant data when a specific status is reached in the controlled process.

It is also advantageous for the client or server to be part of the automation device and communicatively connected to a standard interface of the automation device. The communication requests which are received or sent via the standard interface are processed by the client or server in accordance with the standard protocol. The advantage of such a configuration is that terminals from a wide variety of manufacturers and performance classes can be connected to the automation device via the standard interface, and data can be transferred between the automation device and each connectable terminal in this way.

If the converter presents the object model and its structure to the client or server in a hierarchical format, access to the object model of the automation device can be particularly clear and user friendly.

In accordance with a further configuration of the invention, a structure of the object model is initially called up in order to access the data of the automation device. The structure of the object model is an image of the object model itself. It includes an image of the individual components of the object model, e.g. the organization modules, data modules, function modules, etc. As soon as the image of the object model is available, a selection of the components contained therein is possible. Individual components or a plurality of components are selected accordingly, with reference to the image of the structure of the object model. These components are then accessed, in that data in the memory of the automation device is read or written via the function interface, said data corresponding to the selected components. It is therefore possible to access the object model in the same way as the data on a fixed disk, for example, can be accessed using so-called file managers as found today in popular operating systems. On the basis of relevant training with such file managers, the user knows directly which measures to apply in order to call up data from the object model of the automation device, for example.

It is also advantageous for similar components in the object model to be combined in groups and transferable in groups. This again significantly facilitates access to the object model in that, e.g. when transferring all data modules, the complete group of all data modules can be selected instead of selecting each data module individually. The combining of components into groups continues along the hierarchy within the structure of the object model in such a way that there is also one group which contains all groups having a specific type of module in each case. The grouping at the highest hierarchical level ultimately corresponds to the object model itself, such that a single selection allows all the data resources of the automation device to be selected for the transfer.

It is advantageous for the structure of the object model to be represented as a so-called tree with a so-called root, having at least one so-called branch and at least one so-called leaf. The root corresponds to the grouping at the highest hierarchical level as described above. Each leaf corresponds to a component of the object model, e.g. a data module or function module, and each branch corresponds to a grouped combination of similar components or other branches.

The object model is itself organized into a certain structure which is at least implicit, specifically into a form which comprises a set of organization modules, a set of data modules, a set of function modules, etc. Each type of module is organizationally combined into a single branch, subsequently called a “directory”, wherein the directory itself bears the name of the class of the data it contains or of the organization form, e.g. “Function modules”. If a user switches to the directory called “Function modules”, an appropriate communication request supplies a list of the function modules which are present on the automation device to the user on the terminal side, in accordance with the standard protocol. The user is then presented with the list of function modules, e.g. “FB1, FB2, . . . FB7” and can select e.g. the function module with the number 7 (FB7) from this list for the transfer. This read operation is initiated by the client. As a result of the communication of the client with the server which is connected in front of the automation device, therefore, the user of the terminal on which a corresponding client is present receives the data of the requested function module on his or her terminal, e.g. his or her personal computer, as a transmitted file.

The nested structure described above can also include even deeper levels, where a description of the data, and optionally a description of the program code or at least a representation of the program code which can be read more easily by users, is assigned or generated in addition to the actual data. To this end, provision is made for the image of the structure of the object model to include further directories, which as subdirectories themselves describe the complete data structure of the automation device in each case, but which are assigned different data depending on the path within the directory. An example is a directory having the name “Binary” and a directory having the name “Description”, where each of these directories contains subdirectories for the organization modules, the data modules, the function modules, etc. In order to call up data from the object model, the user switches to the directory called “Binary” first, for example, and from there into the directory called “Organization modules”. If the organization module having the number 7 is then selected, the corresponding organization module is returned in a binary format. By comparison, if the user moves from the directory called “Description” into the directory called “Organization modules” and again selects the organization module having the number 7 from there, the corresponding organization module is returned in a special text format, which facilitates the readability of the data contained in the organization module. For this purpose, when the collection of the data module from the automation device is initiated, an interpretation of the data supplied by the automation device must be performed in addition to a transfer of the data. For an organization module, this transfer functionality can be provided by a so-called disassembler, for example. Alternatively or additionally, provision can be made for holding an organization module in the memory of the automation device both in binary format and in the format in which it can optionally be presented to the user. This is ultimately a question of the memory space available on the automation device. Similar considerations apply to plain text designations for so-called variables which are used in the control program, e.g. “DBl.7=Motor at creep velocity”. This information “Motor at creep velocity” is not usually contained in the data module, but in a separate file called the signal list. In this case, when a specific data module is called up and prepared for transfer via the path “Description” “Data module”, provision is made in advance of the transfer for preparing not just the data module itself for the transfer, but also those entries in the signal list which relate to data of this data module, said entries being added to the transfer data in a suitable format, so that the user can read not just the data module with its layout, but also the plain text designation of the individual variables within the data module.

As an alternative to a comparatively deep nested directory structure, it is possible to have only directories for organization modules, data modules, function modules, etc. as subdirectories of the so-called root directory, and to identify the individual organization modules or data modules as “files” in these subdirectories by means of different so-called extensions according to their content, e.g. an extension of “binary” for binary content only and an extension of “description” for the expanded content with plain text designations as described above.

It is also effective, starting from the root directory, to create directories which designate in plain text the automation devices which belong to an automation system. This can result in subdirectories having the designation “S7-300” and a further directory having the designation “S7-400” if these devices are present in the automation system. If a plurality of automation devices of the same performance class are resent in an automation system, ambiguities arise when naming the directories branching from the root directory. This ambiguity is avoided if a unique number is added to the designation, so that designations such as “S7-300 [1]”, “S7-300 [2]”, etc. are generated. Alternatively, the device class designation is no longer selected as a directory name, and the automation devices are instead designated using the names they were given during design, e.g. “Press control”, etc., or (again with reference to design data) using the geographic positions of the individual automation devices, e.g. “Rack 7 slot 3”, or using a suitable location identifier.

In accordance with a relevant transfer operation, it is also possible on the automation device side or on the terminal side to convert the data of the automation device, said data being identified either as a directory level or by an extension, into a machine-readable format, e.g. XML, which can then be interpreted on the terminal side and can optionally be imported via an additional filter, for example, into a standard program, e.g. a spreadsheet program, a database program, a visualization program, etc.

The invention also addresses the problem of specifying a suitable automation device for executing the method. This problem is solved by an automation device in accordance with Claim 8. The dependent claims relate to preferred embodiments of the invention.

In accordance with the invention, an automation device having a memory and a function interface, wherein the function interface itself is held in the memory and is provided for accessing an object model which is stored in the memory, features a converter and a client and/or a server. The client or server forwards a communication request, which relates to the object model and is therefore used for write or read access to the object model, to the converter. The converter is used for converting the communication request into a format which can be processed by the function interface, and for forwarding the converted communication request to the function interface.

If e.g. a communication request for reading the data module having the number 1 is initiated, this request arrives at the client or server, which is specially configured in this case and is connected in front of the automation device. The client or server recognizes that this is a read request which relates to data in the automation device, the object model. The client or server passes the request to the converter, which knows both the functionality of the client or server and the functionality of the function interface. The converter converts the read request into a corresponding call for reading data from the object model and converts the parameter of the read request, e.g. “DB 1” in this case, into a corresponding parameter for selecting the first data module in the memory of the automation device. A function call is finally generated therefore, which can be transferred to the automation device at its function interface. The generated function call corresponds to a function call such as that which can be generated directly by a proprietary programming device. In response to the function call, the automation device or more precisely its function interface returns the first data module. This data module or its data is transferred to the client or server, which in turn transmits it onward to the counterpart of the client or server on the terminal side, and therefore the data finally arrives at the terminal from which the data module was requested.

It is advantageous if the automation device has both a client and a server and is therefore capable of functioning as both a data source and a data destination in a communication relationship with other communication participants, e.g. other automation devices or terminals.

It is additionally advantageous if the automation device has a standard interface via which the client or server is communicatively connected. The client or server is thus suitable for handling incoming or outgoing communication requests via the standard interface in accordance with a standard protocol, e.g. FTP or NFS. A so-called personal computer, for example, can be connected to the standard interface as a terminal. If the automation device includes a server, the terminal which is used to access the automation device has a corresponding client. Conversely, if the automation device has a client, the terminal has a corresponding server.

It is additionally advantageous if the converter also provides for converting a communication request from the function interface into a format which can be processed by the client or the server, and for forwarding the converted communication request to the client or the server. The automation device can then also function as an active communication partner in a communication relationship and, e.g. send relevant data to the terminal when a specific status is reached in the controlled process. An example is production data which is logged by the automation device during manufacture of a batch and is to be transferred to a supervisory station for the purpose of analysis after the end of the batch.

The client is advantageously an FTP client and the server an FTP server accordingly. This makes it possible to use the File Transfer Protocol (FTP), which is a widely used standard protocol, for accessing the object model of the automation device.

Alternatively, the client is advantageously an NFS client and the server an NFS server accordingly. This makes it possible to use the NFS protocol (NFS=Network File System), which is likewise a widely used standard protocol, for accessing the object model of the automation device.

In accordance with a further alternative, the client is advantageously an NNTP client and the server an NNTP server accordingly. This makes it possible to use the NNTP protocol (NNTP=Network News Transfer Protocol), which is likewise a widely used standard protocol, for accessing the object model of the automation device.

### BRIEF DESCRIPTION OF THE DRAWINGS

An exemplary embodiment of the invention is explained in greater detail below with reference to the drawings. Objects or elements which correspond to each other are assigned the same reference signs in all the figures, in which

FIG. 1 shows an automation device,

FIG. 2 shows an object model of an automation device,

FIG. 3 shows a structure of the object model, and

FIG. 4 shows a structure of a part of the object model, which part also relates to messages, e.g. status, warning or error messages.

### DETAILED DESCRIPTION OF INVENTION

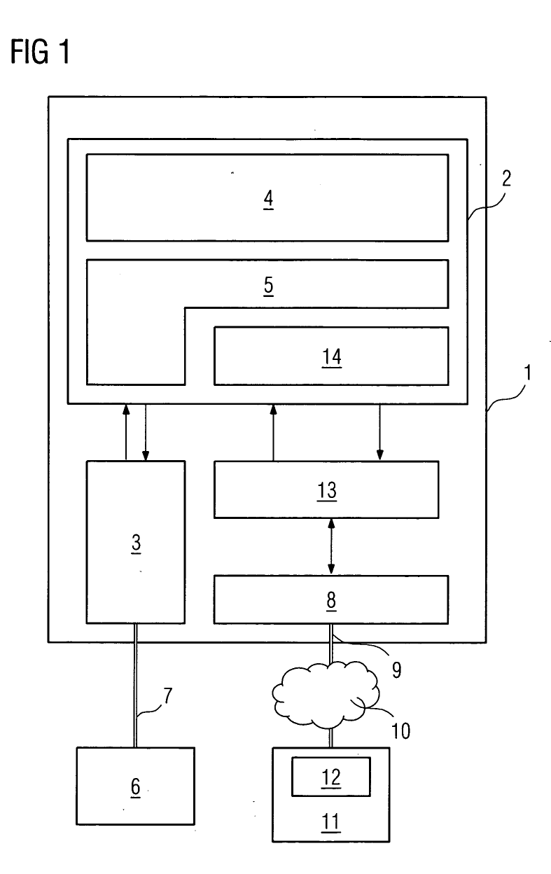

FIG. 1 shows an automation device 1 having a memory 2 and a programming device interface 3. Inter alia, the so-called object model 4 and a function interface 5 for accessing the object model 4 are stored in the memory 2.

The object model 4 of the automation device 1 is accessed by 5 an external programming device 6, via the programming device interface 3 and the function interface 5. The programming device interface 3 allows the establishment of a communication connection 7 between programming device 6 and automation device 1, and acts as an intermediary between programming device 6 and function interface 5. The programming device 6 includes a counterpart (not shown) for converting data which is received from the automation device 1, wherein said counterpart corresponds to the function interface 5.

If data of the object model 4 is to be read, for example, by the programming device 6, a corresponding request arrives at the function interface 5 from the programming device 6 via the programming device interface 3, e.g. “get DB 1” (read data module 1). The function interface 5 includes means (not shown) for interpreting this request in such a way that, for example, it is possible to access that area of the object model 4 which represents the data module having the number 1 in the memory 2. The corresponding memory area is made available by the function interface 5 for transmission to the programming device 6 via the programming device interface 3, and is transmitted to the programming device 6 at a suitable time.

The same applies correspondingly when loading e.g. a function module from the programming device 6 into the object model 4 of the automation device, e.g. “put FB 10” Write function module 10). The function interface 5 allows the access to that area of the object model 4 which represents the relevant function module in the memory 2. The data received from the programming device 6 is written into this memory area.

An automation device 1 having memory 2, object model 4, function interface 5 and programming device interface 3 is known from the prior art.

The automation device 1 also includes a standard interface 8, thereby allowing the connection of any terminal 11, e.g. a standard computer 11 such as are normally used for office applications today, over a corresponding communication connection 9, possibly involving intermediate switching of communication connections via the so-called internet 10.

The so-called protocol which is used for communicating between automation device 1 and programming device 6 is usually a proprietary protocol, which often is specified by the manufacturer of the relevant automation device 1 specifically for said device. In this case, the proprietary nature is essentially derived from the specific functionality of the function interface 5, which includes means for converting requests such as “get DB 1” or “put FB 10” directly into accesses to the object model 4.

In order to allow an exchange of data between the automation device 1 and a standard terminal 11, the proprietary protocol which is used for communicating between automation device 1 and programming device 6 is not used. Instead, general conventional protocols such as FTP or NFS, for example, are used. Software for handling data transfers in accordance with FTP or NFS on the terminal 11 is available in a wide variety of forms, and therefore the user of the terminal 11 can choose from the existing products according to the local requirements or limiting conditions (operating system, memory space).

When software for handling data transfers in accordance with FTP or NFS is executed, either a so-called server 12 or a so-called client 12, or even a server 12 and a client 12, is set up on the terminal 11.

A complementary functionality 13 is provided on the automation device side in order to allow the communication with the client 12 and/or the server 12 of the terminal 11. The description continues by describing the case in which a client 12 is present on the terminal 11 side and a corresponding server 13 is present on the automation device side for handling the standard protocol which is selected in each case.

Communication requests in accordance with the standard protocol are sent from the client 12 to the server 13, e.g. “get DB 1” to transfer the data module having the number 1 from the object model 4 of the automation device 1 to the terminal, or “put FB 10” to transfer a function module from the terminal 11 to the object model 4 at the position in the memory 2 which represents the function module having the number 10. The server 13 passes the communication request to a converter 14, which converts the communication request in accordance with the standard protocol into a communication request which can be handled by the function interface 5 of the automation device 1. The function interface 5 allows the access to the object model 4 of the automation device, and hence the read or write access to the memory 2 in accordance with the original communication request, to take place.

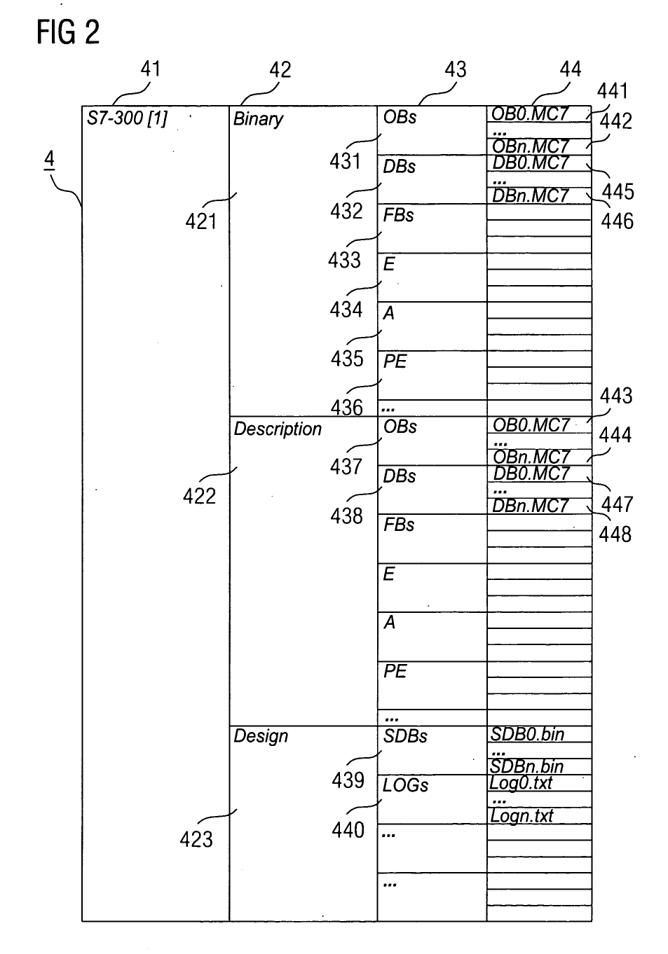

FIG. 2 shows a schematic hierarchical illustration of an object model 4 of an automation device 1. The columns 41, 42, 43, 44 represent hierarchy levels within the object model 4. A highest hierarchy level 41 comprises the complete object model 4 of a specific automation device 1, designated as “S7-300” here. In an underlying hierarchy level 42, the object model is divided into binary data 421, description data 422 and design data 423. In a next lower hierarchy level 43, the binary data 421, for example, is divided into organization modules (OBs) in binary format 431, data modules (DBs) in binary format 432, function modules (FBs) in binary format 433, inputs (E) in binary format 434, outputs (A) in binary format 435, and a process image of the inputs (PE) in binary format 436, etc. The description data 422 is correspondingly divided into organization modules (OBs) having a description 437, data modules (DBs) having a description 438, etc. Finally, the design data 423 is divided into system data modules (SDBs) 439, log files (LOGs) 440, etc. In a lowest hierarchy level 44, the totality of e.g. the organization modules 431, 437 finally comprises the actual individual organization modules (OB0 . . . OBn) 441, 442, 443, 444. The totality of the data modules 432, 438 correspondingly comprises the individual data modules (DB0 . . . DBn) 445, 446, 447, 448 in this lowest hierarchy level 44.

On the basis of this hierarchical structuring of the object model 4, it is possible—as when using known file managers of conventional operating systems—to access not only individual organization modules 441-444 or data modules 445-448, but also the totality of e.g. all organization modules 431, 437 or data modules 432, 438. Accordingly, the complete data resources of the object model 4 can be transferred in binary format 421 or together with explanatory description 422 by means of a single access. Finally, even the object model 4 itself can be selected, and therefore the complete object model can be transferred by means of a single access.

This is possible because the individual elements 441 to 448 of the object model 4, and likewise their grouped combinations 431 to 438, can be managed in the same way as so-called directories (which are also referred to as “folders”) and files are managed when using the aforementioned file managers. The object model 4 and its structure are presented to the server 13 by the converter 14 in the hierarchical format described above.

This breaks through the “one-dimensional structure” which was routinely used until now for the object model in automation devices, since similar components are combined in groups and transferable in groups.

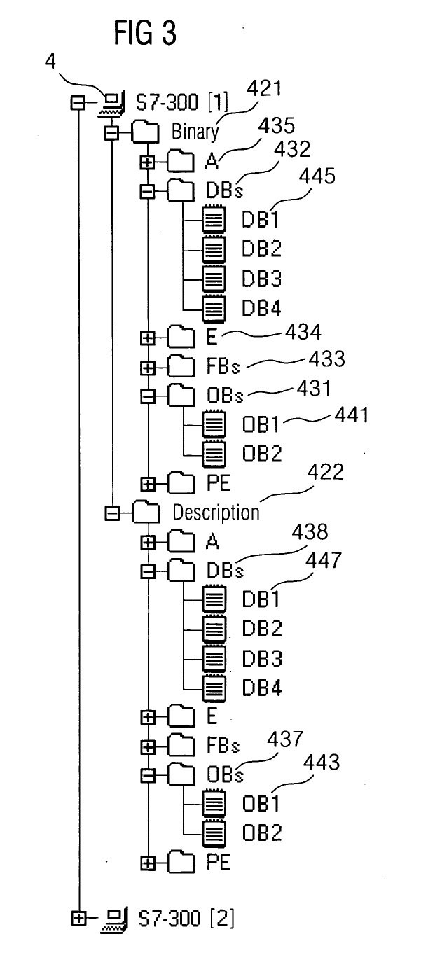

FIG. 3 shows a further illustration of the object model 4 in a format which corresponds to the presentation of a directory structure by conventional file managers today. The reference signs correspond to the reference signs used in FIG. 2. The structure of the object model 4 (“directory”, “dir”) of the relevant automation device 1 can be shown to the user of the terminal 11 initially by means of the communication and transfer commands of the selected standard protocol. The structure of the object model 4 is therefore represented graphically on the screen of the terminal 11, in the manner shown by way of example in FIG. 3. In this graphical representation, the user of the terminal 11 can select individual components to be transferred, e.g. all data modules in binary format 432 or the organization module having the number 1 including description 443.

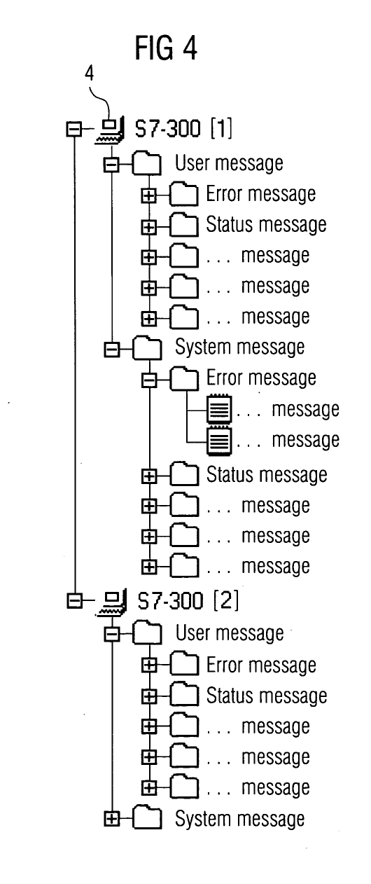

Similarly, messages such as e.g. status or error messages, etc., of the automation device 1 are presented to the user in a convenient way. All messages of the same type, e.g. error messages, are combined into a corresponding group for this purpose. A plurality of groups, e.g. the group of all error messages, the group of all status messages, etc., are combined into a separate group called “System message” if they relate to e.g. the automation device 1 itself, and into a further separate group called “User message” if they relate to e.g. the user program which is executed by the automation device 1. This structure is represented graphically at the screen of the terminal in the manner shown by way of example in FIG. 4.

The user on the terminal 11 side can quickly move through the resulting hierarchical structure to the desired type and category of message, and/or select individual messages or groups of messages to be transferred, e.g. for documentation purposes.

The invention can therefore be summarized as follows:

A method for accessing the data of an automation device 1 and an automation device 1 suitable for the execution thereof are specified, in which an access to the data takes place via a remote terminal 11 in accordance with a standard protocol, wherein the automation device 1 has a client 13 and/or server 13 for handling communication requests in accordance with the standard protocol, and a converter 14 for converting a communication request into a format which can be processed by a function interface 5 which is an internal functionality of the automation device 1 for direct access to its data.

1.-14. (cancelled)

15. A method for accessing data of an automation device having a memory and a function interface, wherein the function interface is stored in the memory and is used for accessing an object model stored in the memory, the method comprising:
forwarding a communication request from a client or a server to a converter, wherein the communication request relates to the object model; and
converting the communication request by the converter into a format which can be processed by the function interface.

16. The method as claimed in claim 15, wherein the converter also converts a communication request from the function interface into a format which can be processed by the client or the server and forwards the converted communication request to the client or the server.

17. The method as claimed in claim 15, wherein the client or server is part of the automation device, is communicatively connected to a standard interface of the automation device, and processes communication requests which are received or sent via the standard interface in accordance with a standard protocol.

18. The method as claimed in claim 15, wherein the object model and its structure are presented to the client or server in a hierarchical format by the converter.

19. The method as claimed in claim 15, wherein the client is an FTP client and/or the server is an FTP server.

20. The method as claimed in claim 15, wherein the client is an NFS client and/or the server is an NFS server.

21. The method as claimed in claim 15, wherein the client is an NNTP client and/or the server is an NNTP server.

22. The method as claimed in claim 15, comprising:
calling up a structure of the object model in the form of its image, wherein the structure comprises individual components of the object model;
selecting individual components or sets of components with reference to the image of the structure of the object model; and
accessing to the individual components or sets of components, wherein data corresponding in the memory to the selected components is written or read via the function interface.

23. The method as claimed in claim 22, wherein similar components of the object model are combined in groups and are transferable in groups.

24. The method as claimed in claim 23, wherein
the structure of the object model is represented as a so-called tree having a so-called root and at least one so-called branch and at least one so-called leaf, wherein
each leaf corresponds to a component of the object model, and wherein
each branch corresponds to a grouped combination of similar components other branches.

25. An automation device, comprising:
a memory;
a function interface, wherein the function interface is stored in the memory and is used for accessing an object model which is stored in the memory;
a converter; and
a data processing system, wherein the data processing system forwards a communication request to access the object model to the converter, and wherein the converter is used for converting the communication request into a format which can be processed by the function interface, and for forwarding the converted communication request to the function interface.

26. The automation device as claimed in claim 25, comprising a client and a server.

27. The automation device as claimed in claim 25, wherein the data processing system is a client.

28. The automation device as claimed in claim 25, wherein the data processing system is a server.

29. The automation device as claimed in claim 25, comprising a standard interface, wherein the client or server is communicatively connected to the standard interface, and is used for processing communication requests which are received or sent via the standard interface in accordance with a standard protocol.

30. The automation device as claimed in claim 25, wherein the converter is also used for converting a communication request from the function interface into a format which can be processed by the client or the server, and for forwarding the converted communication request to the client or the server.

31. The automation device as claimed in claim 25, wherein the client is an FTP client and/or the server is an FTP server.

32. The automation device as claimed in claim 25, wherein the client is an NFS client and/or the server is an NFS server.

33. The automation device as claimed in claim 25, wherein the client is an NNTP client and/or the server is an NNTP server.
